(19) United States
(12) Patent Application Publication
(10) Pub. No.: US 2026/0155541 A1
(43) Pub. Date: Jun. 4, 2026

(54) SECONDARY BATTERY AND METHOD FOR MANUFACTURING SECONDARY BATTERY

(71) Applicant: SAMSUNG SDI CO., LTD., Yongin-si (KR)

(72) Inventors: Dong Hyun KIM, Yongin-si (KR); Ye Jin SEO, Yongin-sI (KR); Eun Jeong MOON, Yongin-si (KR)

(21) Appl. No.: 19/230,367

(22) Filed: Jun. 6, 2025

(30) Foreign Application Priority Data
Dec. 4, 2024 (KR) 10-2024-0178235

(51) Int. Cl. H01M 50/536; H01M 10/0585; H01M 50/105; H01M 50/178; H01M 50/533; H01M 50/534; H01M 50/54

(52) U.S. Cl. CPC H01M 50/536; H01M 10/0585; H01M 50/105; H01M 50/178; H01M 50/533; H01M 50/534; H01M 50/54

(57) ABSTRACT

A secondary battery includes an electrode assembly including a base material tab, the base material tab protruding to one side of the electrode assembly, a case accommodating the electrode assembly, an electrode lead electrically connected to the base material tab, the electrode lead extending to an outside of the case, and an adhesion member on the base material tab and adjacent to the electrode lead.

### CROSS-REFERENCE TO RELATED APPLICATION

This application claims priority to and the benefit of Korean Patent Application No. 10-2024-0178235, filed on Dec. 4, 2024, in the Korean Intellectual Property Office, the entire disclosure of which is incorporated herein by reference.

### BACKGROUND

### 1. Field

Embodiments relate to a secondary battery and a method for manufacturing the secondary battery.

### 2. Description of the Related Art

Unlike a primary battery, a secondary battery may be (re)charged and discharged. Low-capacity secondary batteries having a single battery cell packaged in the form of a pack are widely employed in small, portable electronic devices, such as smart phones, feature phones, laptop computers, digital cameras, camcorders, and the like, while large-capacity secondary batteries are widely used as power sources for driving motors in hybrid vehicles, electric vehicles, and the like, as well as batteries for power storage. The secondary battery includes an electrode assembly composed of a positive electrode and a negative electrode, a case that accommodates the electrode assembly, and electrode terminals connected to the electrode assembly.

Secondary batteries may be classified into circular, prismatic, and pouch types depending on their shapes. Among these, the pouch type secondary battery may be provided as a pouch exterior that is modified in various shapes and has a small weight.

The above information disclosed in this Background section is only for enhancement of understanding of the background of the embodiments and therefore it may contain information that does not constitute prior art.

### SUMMARY

A secondary battery according to an embodiment of the present disclosure for solving the above technical problem, may include: an electrode assembly including a base material tab protruding to one side; a case configured to accommodate the electrode assembly; and an electrode lead electrically connected to the base material tab and extending to the outside of the case, wherein the secondary battery further includes an adhesion member interposed between the base material tab and the electrode lead.

In some embodiments, the base material tab may include: a front end connected to an electrode non-coating portion of the electrode assembly; a rear end to which the electrode lead is connected; and a center point disposed between the front end and the rear end, wherein the base material tab may be bent at the center point.

In some embodiments, the adhesion member may be disposed on a top surface of the rear end.

In some embodiments, the adhesion member may be disposed along an end of the electrode lead at a connected portion of the base material tab and the electrode lead.

In some embodiments, the adhesion member may be disposed on a bottom surface of the rear end.

In some embodiments, the adhesion member may be disposed on a bottom surface of the base material tab, which corresponds to a welding area of the base material tab and the electrode lead.

In some embodiments, the adhesion member may be disposed on at least one of two side surfaces of the rear end.

In some embodiments, the adhesion member may be interposed in a cracked portion of the rear end.

In some embodiments, the base material tab may include a plurality of base material tabs, each of which is connected to an electrode non-coating portion of the electrode assembly, wherein the plurality of base material tabs may be welded together.

In some embodiments, the adhesion member may include a conductive adhesive.

According to some embodiments, a method for manufacturing a secondary battery includes: acquiring an image of a connected portion of a base material tab protruding to one side of an electrode assembly accommodated in a case and an electrode lead electrically connected to the base material tab to extend to the outside of the case; detecting cracks on the basis of the image of the connected portion of the base material tab and the electrode lead; positioning a nozzle at the crack detection portion if the cracks are detected; and applying an adhesion member to the crack detection portion through the nozzle.

In some embodiments, the detecting of the cracks may include identifying crack coordinates on the basis of the image.

In some embodiments, the method may further include, after the applying of the adhesion member, curing the adhesion member.

In some embodiments, the method may further include, after the applying of the adhesion member, pressing a portion, to which the adhesion member is applied, by using a press.

In some embodiments, the press may include a cold press.

In some embodiments, a bottom surface of the press may have a shape corresponding to a shape of the portion to which the adhesion member is applied.

In some embodiments, the press may press the portion, to which the adhesion member is applied, for a set time for which the adhesion member is cured.

In some embodiments, the base material tab may include a front end connected to an electrode non-coating portion of the electrode assembly and a rear end to which the electrode lead is connected, wherein the applying of the adhesion member may include applying the adhesion member to a top surface of the rear end.

In some embodiments, the base material tab may include a front end connected to an electrode non-coating portion of the electrode assembly and a rear end to which the electrode lead is connected, wherein the applying of the adhesion member may include applying the adhesion member to a bottom surface of the rear end.

In some embodiments, the base material tab may include a front end connected to an electrode non-coating portion of the electrode assembly and a rear end to which the electrode lead is connected, wherein the applying of the adhesion member may include applying the adhesion member to at least one of two side surfaces of the rear end.

### BRIEF DESCRIPTION OF DRAWINGS

The following drawings attached to this specification illustrate preferred embodiments of the present disclosure, and serve to further understand the technical idea of the present disclosure together with the detailed description of the present disclosure, and thus, the present disclosure should not be construed as being limited to the matters described in such drawings.

FIG. 1 is a perspective view showing a structure of a secondary battery according to embodiments;

FIG. 2 is a side cross-sectional view of an electrode assembly in which an adhesion member is provided on a top surface of a connected portion between an electrode lead and a base material tab according to embodiments;

FIG. 3 is a side cross-sectional view of an electrode assembly in which an adhesion member is provided on a bottom surface of the connected portion between the electrode lead and the base material tab according to embodiments;

FIG. 4 is a side cross-sectional view of an electrode assembly in which the adhesion member is provided on top and bottom surfaces of the connected portion between the electrode lead and the base material tab according to embodiments;

FIG. 5 is a side cross-sectional view of an electrode assembly in which an adhesion member is provided on a side surface of the connected portion between the electrode lead and the base material tab according to embodiments;

FIG. 6 is an image of a case in which cracks occur in a top surface of a connected portion between an electrode lead and a base material tab;

FIG. 7 is an image of a case in which cracks occur in a bottom surface of a connected portion between an electrode lead and a base material tab;

FIG. 8 is a flowchart of a method for manufacturing a secondary battery according to embodiments;

FIG. 9 is an example of a welding process of an electrode lead and a base material tab in a method for manufacturing a secondary battery according to embodiments;

FIG. 10 is an image of a connected portion between an electrode lead and a base material tab in a method for manufacturing a secondary battery according to embodiments;

FIG. 11 is a view schematically showing a smartphone equipped with a secondary battery according to an embodiment of the present disclosure;

FIGS. 12A and 12B illustrate perspective views of an example of a battery pack; and

FIGS. 13A and 13B illustrate perspective and side views of examples of a vehicle body and a vehicle components.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe embodiments in the best way. Therefore, the embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application. In addition, it will be understood that the terms “comprise or include” and/or “comprising or including,” when used in this specification, specify the presence of stated features, integers, steps, operations, elements, and/or components but do not preclude the presence or addition of one or more other features, integers, steps, operations, elements, components, and/or groups thereof. In addition, when describing embodiments of the present disclosure, the wording “may ˜” or “may be˜” may include “one or more embodiments of the present disclosure.”

In addition, for a better understanding embodiments, the attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” etc., may be used herein to describe various components, these components should not be limited by these terms. These terms are used to distinguish one component from another component. Thus, unless otherwise defined, a first component described below could be termed a second component, without departing from the spirit and scope of the present disclosure.

Throughout the specification, the singular forms are intended to include the plural forms as well, unless the context clearly indicates otherwise.

The arrangement of an arbitrary component on the “upper portion (or lower portion)” or “upper (or lower)” of a component means that an arbitrary component is placed in contact with the upper (or lower) surface of the component. In addition, it may mean that other components may be interposed between the component and any component disposed on (or under) the component.

Also, it will be understood that when an element is referred to as being “coupled to,” “linked to,” or ““connected to” another element, these elements can be directly coupled or connected to each other, another intervening element may be present therebetween, or the respective elements may be coupled, linked, or connected to each other through another elements. In addition, it will be understood that when an element is referred to as being electrically coupled to another element, the element can be directly connected to another element or an intervening element may be present therebetween such that the element and another element are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

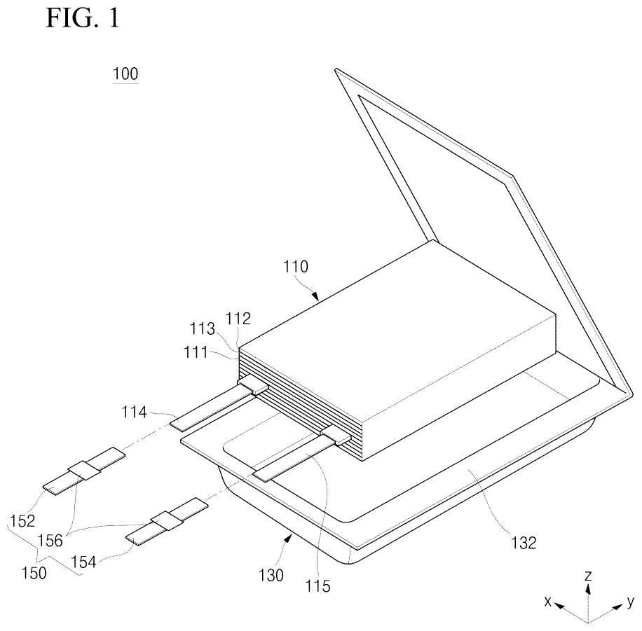

FIG. 1 is a perspective view showing the structure of a secondary battery according to an embodiment.

As shown in FIG. 1, a secondary battery 100 may include an electrode assembly 110 and a pouch 130 that accommodates the electrode assembly 110. The electrode assembly 110 may include a negative electrode plate 111 as a first electrode plate, a positive electrode plate 112 as a second electrode plate, and a separator 113 interposed therebetween. For example, an electrode assembly may be provided by stacking the negative electrode plate 111, the separator 113, and the positive electrode plate 112, each of which is provided in a thin plate shape or film shape. In some examples, the electrode assembly 110 may have one or more electrode assemblies 110 stacked so as to be adjacent to each other to then be accommodated inside the pouch, and the number of electrode assemblies 110 is not limited in the present disclosure. In the electrode assembly 110, the first electrode plate 111 may serve as a negative electrode, and the second electrode plate 112 may serve as a positive electrode. Of course, the opposite is also possible.

The first electrode plate 111 may be formed by applying a first electrode active material such as graphite or carbon on a first electrode current collector formed of a metal foil such as copper, a copper alloy, nickel, or a nickel alloy. The first electrode plate 111 may include a first active material layer to which a first electrode active material is applied. The first electrode plate 111 may include a first uncoated portion, which is a region to which the first electrode active material is not applied.

The negative electrode plate 111 may include a negative electrode tab 114 electrically connected to the first uncoated portion (i.e., a negative electrode non-coating portion). In some embodiments, the negative electrode tab 114 may be fixed (e.g., welded) to the negative electrode non-coating portion in an approximately flat shape. For example, the negative electrode tab 114 may be fixed to the negative electrode non-coating portion by ultrasonic welding, laser welding, or resistance welding. That is, one end of the negative electrode tab 114 may be electrically connected to the negative electrode non-coating portion, and the other end may protrude and extend to the outside. In some examples, the negative electrode tab 114 may be formed by cutting the negative electrode plate 111 in advance so as to protrude to one side when manufacturing the negative electrode plate 111, and may protrude farther to one side than the separator 113 without separately cutting.

A negative electrode active material, the first electrode active material, may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si negative electrode active material or a Sn negative electrode active material may be used as the material capable of being doped and undoped with lithium. The Si negative electrode active material may be silicon, a silicon-carbon composite, SiOₓ (0<x<2), a Si alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate, an ester, an ether, a ketone, an alcohol solvent, an aprotic solvent, and may be used alone or in combination of two or more.

In addition, when a carbonate solvent is used, a mixture of cyclic carbonate and chain carbonate may be used.

The second electrode plate 112 may be formed by applying a second electrode active material such as graphite or carbon on a second electrode current collector formed of a metal foil such as aluminum or an aluminum alloy. The second electrode plate 112 may include a second active material layer to which a second electrode active material is applied. The second electrode plate 112 may include a second uncoated portion, which is a region to which the second electrode active material is not applied.

The positive electrode plate 112 may include a positive electrode tab 115 electrically connected to the second uncoated portion (i.e., to a positive electrode non-coating portion). In some examples, the positive electrode tab 115 may be fixed (e.g., welded) to the positive electrode non-coating portion in an approximately flat shape. For example, the positive electrode tab 115 may be fixed to the positive electrode non-coating portion by ultrasonic welding, laser welding, or resistance welding. That is, one end of the positive electrode tab 115 may be electrically connected to the positive electrode non-coating portion, and the other end may protrude and extend to the outside. In some examples, the positive electrode tab 115 may be formed by cutting the positive electrode plate 112 in advance so as to protrude to one side when manufacturing the positive electrode plate 112, and may protrude farther to one side than the separator 113 without separately cutting.

As a positive electrode active material, the second electrode material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel oxide, a lithium cobalt oxide, a lithium manganese oxide, a lithium iron phosphate compound, a cobalt-free nickel-manganese oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

As the current collector, aluminum (Al) may be used.

In some embodiments, an electrode lead 150 may be provided to electrically connect the negative electrode tab 114 and the positive electrode tab 115 to the outside. The negative electrode tab 114 and the positive electrode tab 115 are respectively welded to a negative electrode lead 152 and a positive electrode lead 154 of an external terminal to be electrically connected to the outside. A tab film 156 for insulation from the pouch 130 is attached to the negative electrode lead 152 and the positive electrode lead 154. The pouch 130 may also be referred to as a case.

The separator 113 may be interposed between the negative electrode plate 111 and the positive electrode plate 112 to prevent electrical short-circuit between the negative electrode plate 111 and the positive electrode plate 112. In some embodiments, the separator 113 may be provided in a pair, and the negative electrode plate 111 may be sandwiched between the pair of separators 113.

Depending on the type of lithium secondary battery, the separator 113 may be present between a positive electrode and a negative electrode. As the separator 113, polyethylene, polypropylene, polyvinylidene fluoride, or a multilayer film of two or more layers thereof may be used.

The separator 113 may include a porous substrate and a coating layer including an organic material, an inorganic material, or a combination thereof on one or both surfaces of the porous substrate.

The organic material may include a polyvinylidene fluoride polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof.

The organic material and the inorganic material may be mixed in one coating layer or may be in the form of a coating layer containing an organic material and a coating layer containing an inorganic material that are laminated on each other.

In a state in which the electrode assembly 110 is accommodated in the pouch 130, sealing parts 132 of edges of the pouch 130 come into contact with each other (e.g., the sealing parts 132 around the periphery of the bottom portion of the pouch 130 come into contact with a corresponding peripheral area of the top potion (e.g., a cover) of the pouch 130) to be sealed. The sealing is performed in a state in which the tab film 156 is disposed between the sealing parts 132. As shown in FIG. 1, the form in which the tab film 156 is attached to each of the negative electrode tab 114 and the positive electrode tab 115 is defined as a “separable tab film” (e.g., this sealing structure is referred to as a separable sealing structure).

The sealing parts 132 at the bottom portion of the pouch 130 as well as the top portion (e.g., the entire cover or at least the peripheral area of the cover) may be made of a heat-fusible material and may have a structure in which sealing is achieved by bonding heat-fusible layers to each other. Because the heat-fusible material generally has weak adhesion to metal, the tab film 156 in the form of a thin film is attached to a tab to be fused to the pouch 130. However, in the separable sealing structure, the tab film 156 is attached to the negative electrode lead 152 and the positive electrode lead 154 and then welded thereto, followed by being heat-fused with the pouch 130, and thus, workability and productivity may be improved. The pouch 130 may have an internal space and may accommodate the electrode assembly 110 in the internal space.

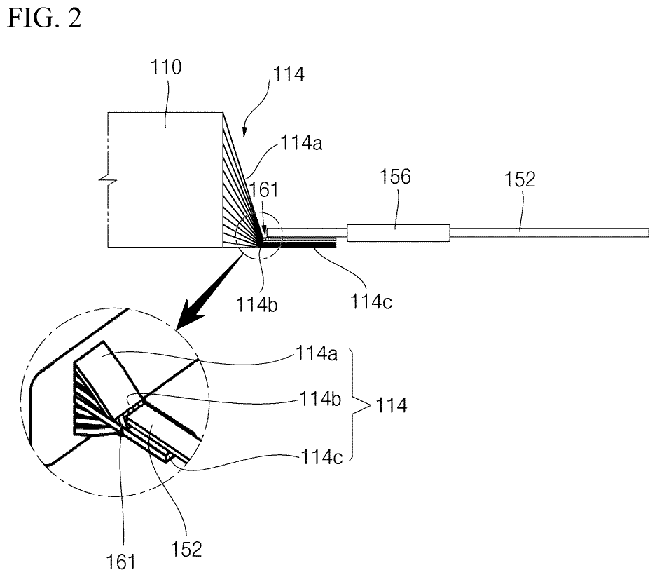

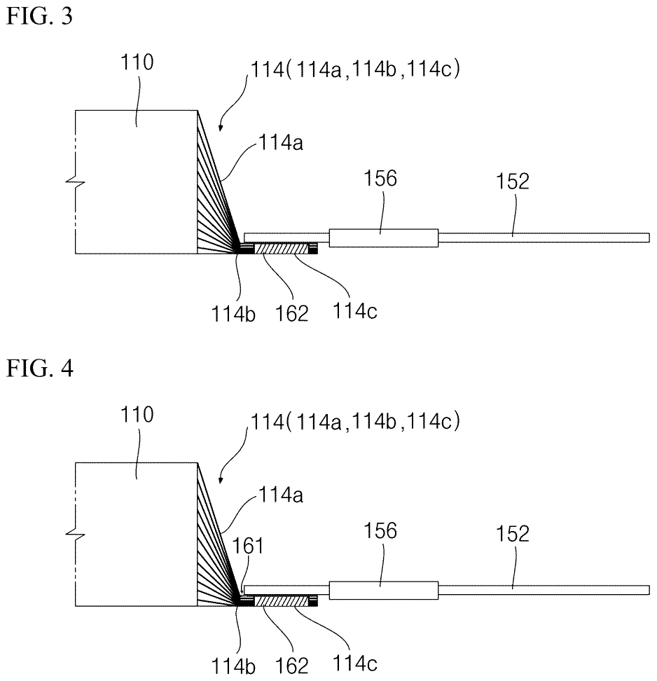

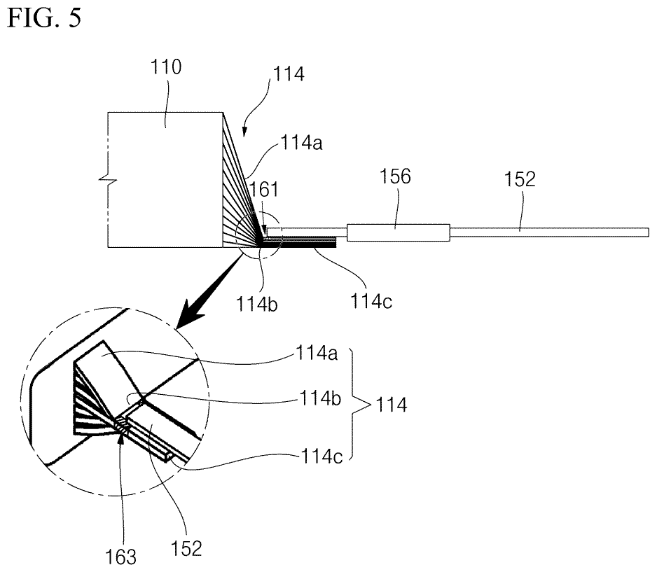

FIG. 2 is a side cross-sectional view of the electrode assembly 110 in which an adhesion member 161 is provided on a top surface of a connected portion between the negative electrode lead 152 and the negative electrode tab 114 according to embodiments. FIG. 3 is a side cross-sectional view of an electrode assembly 110 in which an adhesion member 162 is provided on a bottom surface of the connected portion between the negative electrode lead 152 and the negative electrode tab 114 according to embodiments. FIG. 4 is a side cross-sectional view of an electrode assembly in which the adhesion members 161 and 162 are provided on top and bottom surfaces of the connected portion between the negative electrode lead 152 and the negative electrode tab 114 according to embodiments. FIG. 5 is a side cross-sectional view of an electrode assembly in which an adhesion member 163 is provided on a side surface of a connected portion between the negative electrode lead 152 and the negative electrode tab 114 according to embodiments.

Referring to FIGS. 2 to 5, the secondary battery 100 may include the electrode assembly 110 including the negative electrode tab 114 protruding to one side, the pouch 130 that accommodates the electrode assembly 110, and the electrode lead 150 electrically connected to the negative electrode tab 114 and extending to the outside of the pouch 130. In some embodiments, the electrode lead 150 may include the negative electrode lead 152 and the positive electrode lead 154 connected to the negative electrode tab 114 and the positive electrode tab 115, respectively. For example, the electrode lead 150 may overlap the negative electrode tab 114, such that overlapping portions of the electrode lead 150 and the negative electrode tab 114 may directly contact each other and may be welded to each other.

In some embodiments, the adhesion members 161, 162, and 163 may be provided on at least one of the negative electrode tab 114 or the positive electrode tab 115. In this specification, because the structures of the positive and negative electrode leads and tabs are substantially the same (so the description of the negative electrode tab 114 and the negative electrode lead 152 may be similarly applied to the positive electrode tab 115 and the positive electrode lead 154), and because the adhesion members 161, 162, and 163 may be similarly applied to the negative electrode tab 114 and the positive electrode tab 115, mainly the negative electrode tab 114 will be described and referred to as a base material tab 114. Further, the negative electrode lead 152 and the electrode lead 150 may be referred to interchangeably, for convenience.

In some embodiments, the secondary battery 100 may be welded between the base material tab 114 and the negative electrode lead 152, and all of the base material tabs 114 extending from the electrode non-coating portion may be coupled and welded to the negative electrode lead 152 to generate a current flow path. In some embodiments, the welding between the base material tab 114 and the negative electrode lead 152 may be performed by, for example, ultrasonic welding.

In some embodiments, the secondary battery 100 may include the adhesion members 161, 162, and 163 interposed between the base material tab 114 and the electrode lead 150 (i.e., the negative electrode lead 152). In some embodiments, each of the adhesion members 161, 162, and 163 may include a conductive adhesive. For example, each of the adhesion members 161, 162, and 163 may be a conductive polymer including polyaniline (PANI), polythiophene, polyacetylene, poly(3,4-ethylenedioxythiophene) (PEDOT), polyvinyl alcohol (PVA), etc. For example, each of the adhesion members 161, 162, and 163 may include a silver-containing adhesive, a copper-containing adhesive, a carbon black or graphene-containing adhesive, a nickel-containing adhesive, etc.

In some embodiments, the base material tab 114 may include a plurality of base material tabs 114, each of which is connected to an electrode non-coating portion of the electrode assembly 110, and the plurality of base material tabs 114 may be welded together. In some embodiments, the electrode non-coating portion of the electrode assembly 110 may form the base material tab 114. The base material tab 114 may be provided in plurality and may protrude from a negative electrode plate 111. The base material tab 114 may protrude in a certain direction from the negative electrode plate 111 to overlap each other at one side.

In some embodiments, the base material tab 114 may include a front end 114a connected to the electrode non-coating portion of the electrode assembly 110, a rear end 114c to which the negative electrode lead 152 is connected, and an intermediate point 114b (e.g., a center point) disposed between the front end 114a and the rear end 114c. For example, referring to FIG. 2, the front end 114a may be directly connected to the electrode non-coating portion of the electrode assembly 110, and may extend from the electrode assembly 110 toward the negative electrode lead 152. For example, referring to FIG. 2, the rear end 114c may extend in parallel to the negative electrode lead 152, and may be welded to the negative electrode lead 152. For example, referring to FIG. 2, the intermediate point 114b may be a connection point between the front end 114a and the rear end 114c. In some embodiments, the base material tab 114 may be bent at the intermediate point 114b. In some embodiments, the base material tab 114 to which the negative electrode lead 152 is connected may be bent at least once at the intermediate point 114b and then accommodated in the pouch 130.

In some embodiments, the adhesion members 161, 162, and 163 may be interposed in cracked portions of the rear end 114c. In some embodiments, the negative electrode lead 152 may be welded in a state of being coupled on a top surface of the base material tab 114. In some embodiments, the adhesion members 161, 162, and 163 may be interposed in at least one of a top surface, a bottom surface, or a side surface of the rear end 114c.

In detail, referring to FIG. 2, the adhesion member 161 may be disposed on the top surface of the rear end 114c (e.g., the adhesion member 161 may be disposed on the top surface of the rear end 114c that faces and is covered by a portion of the negative electrode lead 152). For example, referring to FIG. 2, the adhesion member 161 may be between the top surface of the rear end 114c and the bottom surface of the negative electrode lead 152, e.g., the adhesion member 161 may be parallel to and may vertically overlap the rear end 114c and the negative electrode lead 152.

For example, if welding the base material tab 114 to the negative electrode lead 152, an upper portion of the negative electrode lead 152 may be compressed to cause cracks along an end of the electrode lead 152 (e.g., along an end of the electrode lead 152 that overlaps the top surface of the rear end 114c). In some embodiments, the adhesion member 161 may be disposed along the end of the negative electrode lead 152 at a connected portion between the base material tab 114 and the negative electrode lead 152 (e.g., the adhesion member 161 may be disposed along the end of the negative electrode lead 152 that overlaps the top surface of the rear end 114c). In some embodiments, the adhesion member 161 may be interposed along an entire end line of the negative electrode lead 152. In some embodiments, the adhesion member 161 may be interposed in at least a portion of the end line of the negative electrode lead 152.

Referring to FIG. 3, the adhesion member 162 may be disposed on the bottom surface of the rear end 114c (e.g., the adhesion member 162 may be disposed on the bottom surface of the rear end 114c that faces away from the negative electrode lead 152). For example, referring to FIG. 3, the adhesion member 162 may overlap a welding area of the rear end 114c of the base material tab 114 and the electrode lead 152.

For example, if welding the base material tab 114 and the negative electrode lead 152, cracks may occur in a welding area of the base material tab 114 at a lower side of the negative electrode lead 152. In some embodiments, the adhesion member 162 may be disposed on the bottom surface of the base material tab 114 corresponding to the welding area of the base material tab 114 and the negative electrode lead 152. In some embodiments, the adhesion member 162 may be interposed in the entire welding area. In some embodiments, the adhesion member 162 may be interposed in at least a portion of the welding area. In some embodiments, cracks may occur in all or a portion of the plurality of base material tabs 114 corresponding to the welding area, and the adhesion member 162 may be interposed in all or a portion of the plurality of base material tabs 114.

Referring to FIG. 4, the adhesion members 161 and 162 may be disposed on the top and bottom surfaces of the rear end 114c. For example, the adhesion members 161 and 162 may be disposed along the end of the negative electrode lead 152 at the connected portion between the base material tab 114 and the negative electrode lead 152 and may be disposed on the bottom surface of the base material tab 114 corresponding to the welding area of the base material tab 114 and the negative electrode lead 152. For example, referring to FIG. 4, the adhesion members 161 and 162 may be on opposite surfaces of the rear end 114c, and may overlap each other in the vertical direction.

Referring to FIG. 5, the adhesion member 163 may be disposed on at least one of two side surfaces of the rear end 114c. For example, referring to FIG. 5, the adhesion member 163 may extend to a predetermined depth into the base material tab 114 along at least one of two side surfaces of rear end 114c, e.g., the adhesion member 163 may be horizontally offset from the negative electrode lead 152.

For example, if welding the base material tab 114 to the negative electrode lead 152, the upper portion of the negative electrode lead 152 may be compressed to cause cracks along the end of the electrode lead 152 on a side surface of all or a portion of the plurality of base material tabs 114. In some embodiments, the adhesion member 163 may be interposed on a side surface of all or a portion of the plurality of base material tabs 114 along the end of the negative electrode lead 152. In some embodiments, the adhesion members 161, 162, and 163 may be interposed in all of the top, bottom, and side surfaces of the rear end 114c.

In some embodiments, the top surface may mean a portion of the uppermost base material tab 114 that is in contact with the electrode lead 152, and the side surface may mean a side surface of each of the plurality of base material tabs 114 at a coupled portion of the base material tab 114 and the electrode lead 152. In some embodiments, a portion of the side surface may be included in at least one of the top surface or the bottom surface, and a portion of the top surface may be included in the side surface. In some embodiments, a portion of the bottom surface may be included on the side surface.

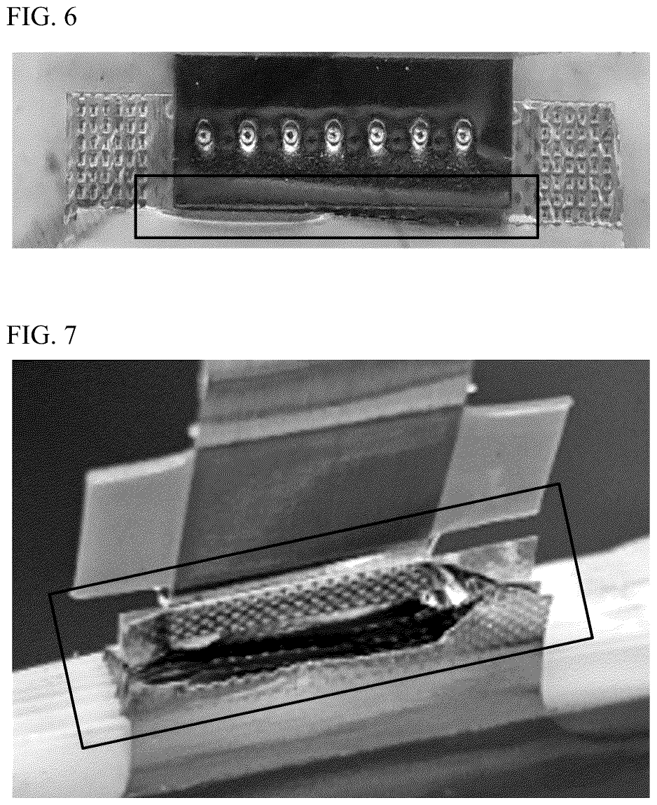

FIG. 6 is an image of a comparative structure in which cracks occur in a top surface of a connected portion between an electrode lead and a tab. FIG. 7 is an image of a comparative structure in which cracks occur in a bottom surface of a connected portion between an electrode lead and a tab.

Referring to FIGS. 6 and 7, when welding a base material tab to a negative electrode lead in a structure without an adhesion member, cracks and holes may occur depending on welding (e.g., ultrasonic welding) conditions, thereby causing tear of the base material. For example, as illustrated in FIG. 6, cracks may occur along an end line of the electrode lead at a portion at which the base material tab and the electrode lead are connected. In another example, as illustrated in FIG. 7, cracks may occur in a portion of a bottom surface of the base material tab on the welding area of the portion at which the base material tab and the electrode lead are connected. In some embodiments, if a plurality of sheets of the base materials are torn, the current flow may be interrupted, approximately 30% to 40% of capacity may be lost, or most of the current paths may be disconnected due to severe cracks (hard cracks) in the plurality of sheets of the base materials.

In general, if the cracks occur in the base material, the portion at which the cracks occur may be discarded without performing post-processing, or if it is not detected by visual monitoring, a cell that is out of specifications through formation cell capacity verification in a formation process may be discarded. For example, if serious cracks occur, and a portion of the materials become unusable, the capacity may be reduced, and the battery may be classified as having poor capacity during charging and discharging.

In contrast, according to embodiments, the current flow path may be restored through repair via an adhesion member, if cracks occur. That is, if cracks occur in the base material, a product having crack defects may be repaired by reconnecting the base material through the adhesion member to restore the current transfer path.

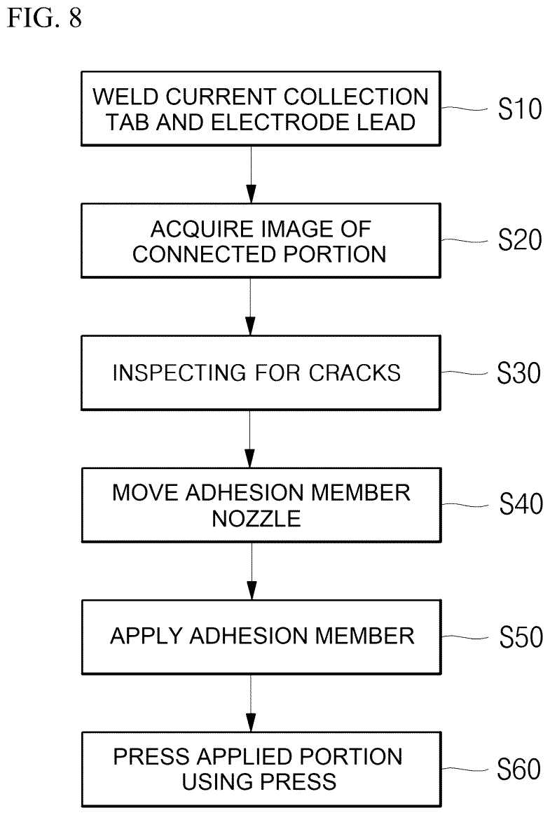

FIG. 8 is a flowchart of a method for manufacturing a secondary battery according to embodiments.

Referring to FIG. 8, a method for manufacturing a secondary battery according to embodiments may include welding a current collection tab and an electrode lead (S10), acquiring an image of a connected portion (S20), inspecting for cracks (S30), moving an adhesion member nozzle (S40), applying the adhesion member (S50), and pressing the applied portion (S60). During inspection for cracks (S30), if cracks are detected, the adhesion member is applied (S40 through S60).

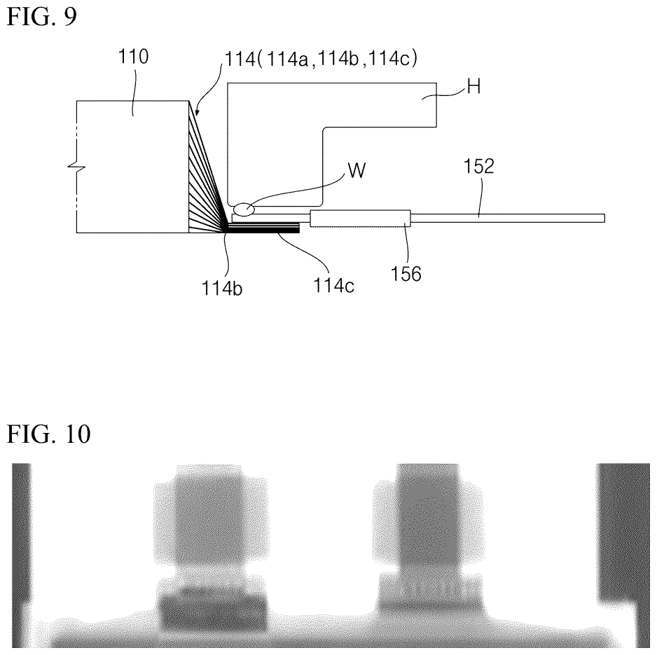

FIG. 9 is an example of a welding process of the negative electrode lead 152 and the base material tab 114 in a method for manufacturing a secondary battery according to embodiments.

Referring to FIG. 9, during welding the current collection tab and the electrode lead (S10), the base material tab 114 and the negative electrode lead 152 may be welded at a welding area W by a welding device H. The negative electrode lead 152 may be welded using the welding device H in a state of being connected to an upper part of each of all the base material tabs 114. All the base material tabs 114 and the electrode lead 152 may be welded to generate a current flow path. For example, the welding device H may be a horn used in ultrasonic welding. The ultrasonic welding horn may receive ultrasonic energy to transmit the ultrasonic energy to a material to be welded, may intensively transmit ultrasonic vibrations generated by the welding device, and may be in direct contact with the target material during the process. If the welding is performed, cracks may occur along an end of the negative electrode lead 152 as the welding device H is pressed from an upper side of the negative electrode lead 152.

FIG. 10 is an example of an acquired image of a connected portion between am electrode lead and a base material tab in the method for manufacturing the secondary battery according to embodiments.

Referring to FIG. 10, when acquiring an image of a connected portion (S20), an image of the connected portion of the base material tab 114 protruding from one side of the electrode assembly 110 accommodated in the pouch 130 and the negative electrode lead 152 electrically connected to the base material tab 114 may be acquired. For example, the image of the connected portion of the base material tab 114 and the negative electrode lead 152 may be acquired by photographing the connected portion through a radiation imaging device (or an X-ray imaging system, an X-ray scanner, etc.). In some embodiments, the image of the connected portion of the base material tab 114 and the negative electrode lead 152 may be acquired using an industrial vision camera that provides high resolution and high frame rate.

Inspecting for cracks (S30) may include detecting cracks based on the image of the connected portion of the base material tab 114 and the negative electrode lead 152 acquired in S20. In some embodiments, coordinates of a portion at which the cracks occur may be identified based on the image of the connected portion of the base material tab 114 and the negative electrode lead 152. In some embodiments, image processing and computer vision techniques may be utilized to acquire the coordinates of the portion at which the cracks occur. For example, image quality may be improved through pre-processing, e.g., removing noise from the acquired image of the connected portion of the base material tab 114 and the negative electrode lead 152 and adjusting contrast. In some embodiments, a crack detection algorithm (e.g., an edge detection algorithm) that is capable of automatically detecting the cracks may be applied to the image. In some embodiments, after the cracks are detected, pixel coordinates (e.g., relative location within the image) of the corresponding position may be extracted.

Moving the adhesion member nozzle (S40) may include disposing the nozzle at the portion at which the cracks are detected. The nozzle may descend to an upper side of the crack detection portion between the base material tab 114 and the negative electrode lead 152 or may ascend to a lower side of the crack detection portion between the base material tab 114 and the negative electrode lead 152.

Applying the adhesion member (S50) may include applying the adhesion members 161, 162, and 163 to the crack detection portion through the nozzle. In some embodiments, the base material tab 114 may include the front end 114a connected to an electrode non-coating portion of the electrode assembly 110 and the rear end 114c to which the negative electrode lead 152 is connected. In some embodiments, the adhesion member 161 may be applied to a top surface of the rear end 114c. In some embodiments, the adhesion member 162 may be applied to a bottom surface of the rear end 114c. In some embodiments, the adhesion member 163 may be applied to at least one of two side surfaces of the rear end 114c.

In some embodiments, after applying the adhesion members 161, 162, and 163, the adhesion members 161, 162, and 163 may be cured. For example, various curing methods such as thermal curing, UV curing, room temperature curing, and moisture curing may be applied.

In some embodiments, pressing the applied portion (S60), after applying the adhesion members 161, 162, and 163 (S50), may include pressing the portion at which the adhesion members 161, 162, and 163 are applied by a press. In some embodiments, the press may be a cold press. For example, the adhesion members 161, 162, and 163 may be pressed through the cold press, and thus, a temperature of each of the adhesion members 161, 162, and 163 may be lowered so that viscosity is lowered, and the adhesion members are cured.

In some embodiments, because the portion at which the adhesion members 161, 162, and 163 are applied is pressed by the press, a bottom surface of the press may have a shape corresponding to a shape of the portion at which the adhesion members 161, 162, and 163 are applied. For example, the adhesion members 161, 162, and 163 of the base material tab 114 may be provided in a shape of a long bar in a width direction of the electrode assembly 110 to press the portion at which the adhesion members 161, 162, and 163 are applied.

In some embodiments, the press may press the portion to which the adhesion members 161, 162, and 163 are applied for a set period of time during the curing of the adhesion members 161, 162, and 163. For example, if using the cold press, a pressure may play an important role. An appropriate pressure has to be applied so that good adhesion is formed between the materials, and the curing process may be performed effectively. A degree of the pressure and duration of the pressure may vary depending on the type of the adhesive and the required adhesion strength. In some embodiments, if using a cold press, because heat is not used, the curing may take a longer time (e.g., compared to a heat curing method), in order to allow a sufficient time for the adhesive to be fully cured.

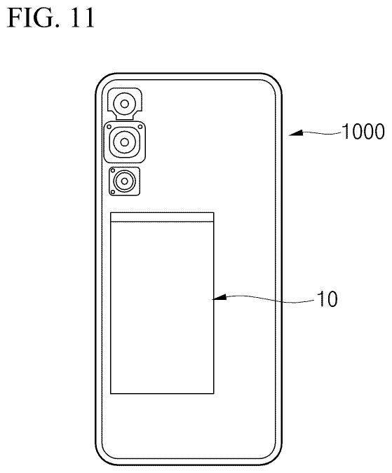

FIG. 11 is a view schematically showing a smartphone 1000 equipped with a secondary battery 10 according to an embodiment of the present disclosure.

As shown in FIG. 11, a secondary battery 10 according to the above-described embodiment of the present disclosure may be a small battery mounted in a small portable device such as a smartphone 1000. In this case, because the exemplary secondary battery 10 is configured to be able to increase the capacity thereof while having a slim internal structure, the above-described secondary battery 10 may be a battery suitable for application to small portable devices. As used herein, the terms “secondary battery” and “battery” have the same meaning and are different only in expression for convenience of description. The secondary battery according to the above-described embodiment may be increased in size to be used to manufacture a battery pack.

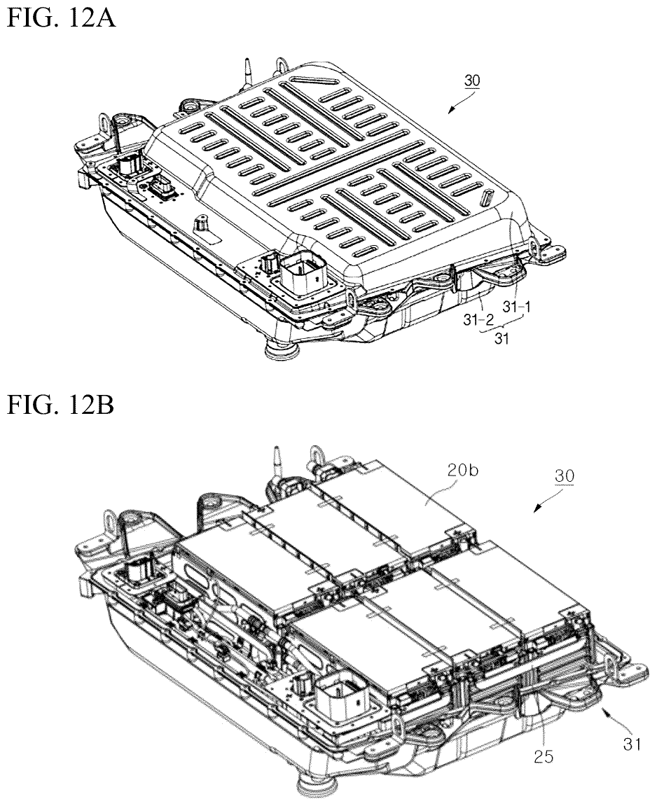

FIGS. 12A and 12B are perspective views showing an exemplary battery pack 30.

Referring to FIGS. 12A and 12B, the battery pack 30 may include a plurality of battery modules 20b and a housing 31 for accommodating the plurality of battery modules 20b. For example, the housing 31 may include first and second housings 31-1 and 31-2 coupled in opposite directions through the plurality of battery modules 20b. The plurality of battery modules 20b may be electrically connected to each other by using a bus bar 25-1, and the plurality of battery modules 20b may be electrically connected to each other in a series/parallel or series-parallel mixed method, thereby obtaining required electrical output.

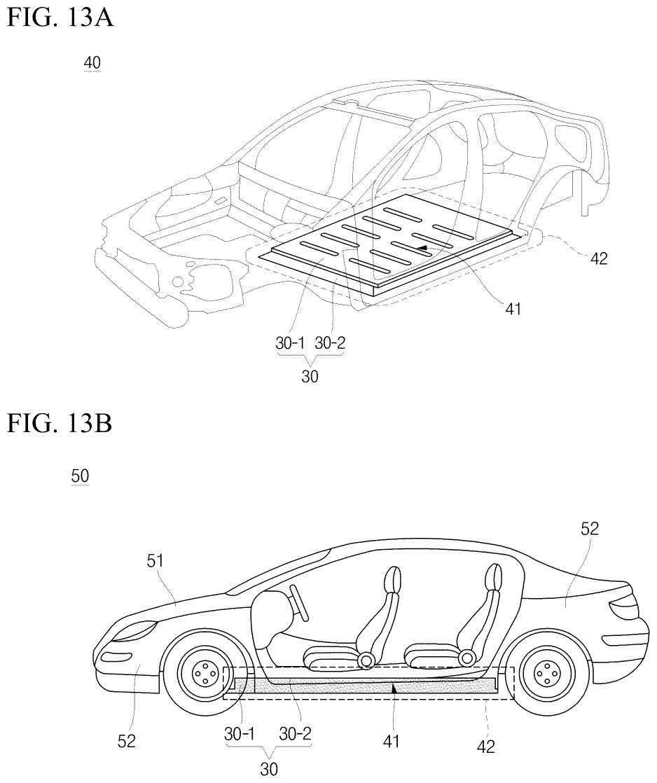

FIGS. 13A and 13B illustrate perspective and side views of examples of a vehicle body 40 and a vehicle components.

In FIG. 13A, a battery pack 30 may include a battery pack cover 30-1, which is a part of a vehicle underbody 41, and a pack frame 30-2 located under the vehicle underbody 41. In some examples, the battery pack cover 30-1 may correspond to the first housing 31-1, and the pack frame 30-2 may correspond to the second housing 31-2. The pack frame 30-2 and the battery pack cover 30-1 may be integrally formed with a vehicle floor 42. The vehicle underbody 41 separates the inside and outside of a vehicle, and the pack frame 30-2 may be located outside the vehicle.

Referring to FIG. 13B, a vehicle 50 may be formed by combining additional parts, such as a hood 51 in front of the vehicle and fenders 52 respectively located in the front and rear of the vehicle to a vehicle body 40. The vehicle 50 may include the battery pack 30 that include the battery pack cover 30-1 and the pack frame 30-2, and the battery pack 30 may be coupled to the vehicle body 40.

By way of summation and review, a secondary battery may include an adhesion member to repair cracks occurring between an electrode tab and an electrode lead, thereby reducing an occurrence of defects, and a method for manufacturing the secondary battery. That is, according to the present disclosure, the cracks occurring between the electrode tab and the electrode lead of the electrode assembly may be repaired to restore the disconnected current flow path and reduce the occurrence of the defects.

However, the technical effects to be achieved in the embodiment of the disclosure are not limited to those mentioned above, and other technical effects not mentioned herein will be clearly understood from the above description by those skilled in the art to which the disclosure belongs.

Although a few embodiments of the present disclosure have been shown and described, it would be appreciated by those skilled in the art that various changes and modifications may be made in this embodiment without departing from the principles and spirit of the disclosure, the scope of which is defined in the appended claims and their equivalents.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an electrode assembly including a base material tab, the base material tab protruding to one side of the electrode assembly;
a case accommodating the electrode assembly;
an electrode lead electrically connected to the base material tab, the electrode lead extending to an outside of the case; and
an adhesion member on the base material tab and adjacent to the electrode lead.

2. The secondary battery as claimed in claim 1, wherein the base material tab includes:
a front end connected to an electrode non-coating portion of the electrode assembly;
a rear end connected to the electrode lead; and
a center point between the front end and the rear end, the base material tab being bent at the center point.

3. The secondary battery as claimed in claim 2, wherein the adhesion member is on a top surface of the rear end, the adhesion member being between the base material tab and the electrode lead.

4. The secondary battery as claimed in claim 3, wherein the adhesion member extends along an end of the electrode lead at a connected portion of the base material tab and the electrode lead.

5. The secondary battery as claimed in claim 2, wherein the adhesion member is on a bottom surface of the rear end of the base material tab.

6. The secondary battery as claimed in claim 5, wherein the adhesion member overlaps a welding area of the base material tab and the electrode lead.

7. The secondary battery as claimed in claim 2, wherein the adhesion member is on at least one of two side surfaces of the rear end of the base material tab.

8. The secondary battery as claimed in claim 2, wherein the adhesion member is in a cracked portion of the rear end of the base material tab.

9. The secondary battery as claimed in claim 1, wherein the base material tab includes a plurality of base material tabs, each of the plurality of base material tabs being connected to an electrode non-coating portion of the electrode assembly, and the plurality of base material tabs being welded together.

10. The secondary battery as claimed in claim 1, wherein the adhesion member includes a conductive adhesive.

11. A method for manufacturing a secondary battery, the method comprising:
accommodating an electrode assembly in a case, such that a base material tab protrudes to one side of the electrode assembly, and an electrode lead electrically connected to the base material tab extends to an outside of the case;
acquiring an image of a connected portion of the base material tab and the electrode lead;
inspecting for cracks in the image of the connected portion of the base material tab and the electrode lead;
if cracks are detected, positioning a nozzle at the cracks; and
applying an adhesion member to the cracks through the nozzle.

12. The method as claimed in claim 11, wherein inspecting for the cracks includes identifying crack coordinates in the image.

13. The method as claimed in claim 11, further comprising, after applying the adhesion member, curing the adhesion member.

14. The method as claimed in claim 11, further comprising, after applying of adhesion member, pressing a portion, to which the adhesion member is applied, by using a press.

15. The method as claimed in claim 14, wherein pressing the portion with the press includes using a cold press.

16. The method as claimed in claim 14, wherein pressing the portion with the press includes using a press with a bottom surface that has a shape corresponding to a shape of the portion to which the adhesion member is applied.

17. The method as claimed in claim 14, wherein pressing the portion with the press includes pressing the portion, to which the adhesion member is applied, for a set time for which the adhesion member is cured.

18. The method as claimed in claim 11, wherein:
the base material tab includes a front end connected to an electrode non-coating portion of the electrode assembly and a rear end connected to the electrode lead, and
applying of the adhesion member includes applying the adhesion member to a top surface of the rear end.

19. The method as claimed in claim 11, wherein:
the base material tab includes a front end connected to an electrode non-coating portion of the electrode assembly and a rear end connected to the electrode lead, and
applying the adhesion member includes applying the adhesion member to a bottom surface of the rear end.

20. The method as claimed in claim 11, wherein:
the base material tab includes a front end connected to an electrode non-coating portion of the electrode assembly and a rear end connected to the electrode lead, and
applying the adhesion member includes applying the adhesion member to at least one of two side surfaces of the rear end.
